(19) United States
(12) Patent Application Publication
(10) Pub. No.: US 2009/0293098 A1
(43) Pub. Date: Nov. 26, 2009

(54) SYSTEMS, METHODS, AND COMPUTER PRODUCTS FOR SEARCHING FOR UNSCHEDULED PROGRAMS AND RELATED PROCESSING

(75) Inventor: Akbar Pirani, Marietta, GA (US)

Correspondence Address: AT&T Legal Department - CC;Attn: Patent Docketing, Room 2A-207, One AT&T Way, Bedminster, NJ, 07921, US

(73) Assignee: AT & T DELAWARE INTELLECTUAL PROPERTY, INC., Wilmington, DE (US)

(21) Appl. No.: 12/126,270

(22) Filed: May 23, 2008

(51) Int. Cl. H04N 7/173

(52) U.S. Cl. 725/132; 725/134

(57) ABSTRACT

Systems, methods and computer products for DVR searching, scheduling and recording for unscheduled programs and programs outside an electronic programming guide. Exemplary embodiments include an unscheduled program searching, scheduling, and recording method, including receiving program data related to a currently unscheduled program, receiving a recording request for scheduling recording of the currently unscheduled program at a date when the currently unscheduled program becomes available as a scheduled program, storing the recording request for the currently unscheduled program and in response to the currently unscheduled program becoming available as the scheduled program, scheduling the scheduled program for recording.

### BACKGROUND

Embodiments relate generally to Internet Protocol Television (IPTV) and digital (personal) video recorders (DVR), and more particularly, to systems, methods and computer products for DVR searching, scheduling and recording for unscheduled programs, and programs outside an electronic programming guide.

Internet protocol television (IPTV) is a digital television delivery service wherein the digital television signal is delivered to residential users via a computer network infrastructure using the Internet Protocol. Typically, IPTV services are bundled with additional Internet services such as Internet web access and voice over Internet protocol (VOIP). Subscribers receive IPTV services via a set-top box that is connected to a television or display device for the reception of a digital signal. Used in conjunction with an IP-based platform, the set-top box allows for a subscriber to access IPTV services and any additional services that are integrated within the IPTV service. In addition, DVRs can be coupled to the IPTV-enabled devices in order to record the content available from IPTV.

IPTV service platforms allow for an increase in the interactive services that can be provided to residential subscribers. As such, a subscriber can have access to a wide variety of content that is available via the IPTV service or the Internet. For example, a subscriber may utilize interactive services via a set top box to view IPTV content or access their personal electronic messaging accounts via an Internet web browser. The IPTV infrastructure also allows the delivery of a variety of video content instantly to the subscribers. Such content can be recorded on the subscriber's DVR.

Current DVR capability enables a subscriber to search for programs via an electronic programming guide (EPG) and to schedule recordings based on current and future programming, typically two weeks into the future. However, subscribers are given very little DVR management and scheduling capability with respect to options in handling DVR recording schedules. For example, current DVR schedules also do not give the subscriber the ability to search for unscheduled future content.

### BRIEF SUMMARY

Exemplary embodiments include an unscheduled program searching, scheduling, and recording method, including receiving program data related to a currently unscheduled program, receiving a recording request for scheduling recording of the currently unscheduled program at a date when the currently unscheduled program becomes available as a scheduled program, storing the recording request for the currently unscheduled program and in response to the currently unscheduled program becoming available as the scheduled program, scheduling the scheduled program for recording.

Additional exemplary embodiments include an unscheduled program searching, scheduling, and recording system, including a processor communicating with memory, the memory storing processor-executable instructions for receiving program data related to a currently unscheduled program, receiving a recording request for scheduling recording of the currently unscheduled program at a date when the currently unscheduled program becomes available as a scheduled program, storing the recording request for the currently unscheduled program and in response to the currently unscheduled program becoming available as the scheduled program, scheduling the scheduled program for recording.

Further exemplary embodiments include a computer program product for providing unscheduled program searching, scheduling, and recording services, the computer program product including instructions for causing a computer to implement a method, including receiving program data related to a currently unscheduled program, receiving a recording request for scheduling recording of the currently unscheduled program at a date when the currently unscheduled program becomes available as a scheduled program, storing the recording request for the currently unscheduled program and in response to the currently unscheduled program becoming available as the scheduled program, scheduling the scheduled program for recording.

Additional exemplary embodiments include an unscheduled program searching, scheduling, and recording method, including receiving meta-data, the meta-data being related to a currently unscheduled program and storing the meta-data for the currently unscheduled program in a preferences folder.

Further exemplary embodiments include an unscheduled program searching, scheduling, and recording method, including receiving and storing meta-data related to a currently unscheduled program, receiving program data related to the currently unscheduled program indicating that the currently unscheduled program is available for scheduling, comparing the meta-data to the program data and if the meta-data matches the program data, then scheduling the program for recording.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a block diagram of a system for DVR searching, scheduling and recording for unscheduled programs and programs outside an electronic programming guide in accordance with exemplary embodiments;

FIG. 2 illustrates a flow chart of an unscheduled program searching, scheduling, and recording method in accordance with exemplary embodiments; and

FIG. 3 illustrates a flow chart of an unscheduled program searching, scheduling, and recording method in accordance with exemplary embodiments.

The detailed description explains the exemplary embodiments, together with advantages and features, by way of example with reference to the drawings.

### DETAILED DESCRIPTION OF EXEMPLARY EMBODIMENTS

Exemplary embodiments include systems, methods and computer products for DVR searching, scheduling and recording for unscheduled programs, and programs outside an electronic programming guide. In exemplary embodiments, if a subscriber wants to search for and possibly record a program on a DVR (or other storage device), but the program has not yet been scheduled or released, the systems and methods described herein can search for programs that have been identified for release at some future date. As such, the subscriber can alert the content provider that the subscriber would like to schedule and record the program when it is released. In other exemplary embodiments, a preferences folder can be set up that include as much meta data as possible such that a content provider can periodically access the folder to ascertain whether a newly released or soon to be released program matches the preference data. As such, a subscriber can provide meta data to the folder, and the content provider can send a message to the subscriber if there is a future match.

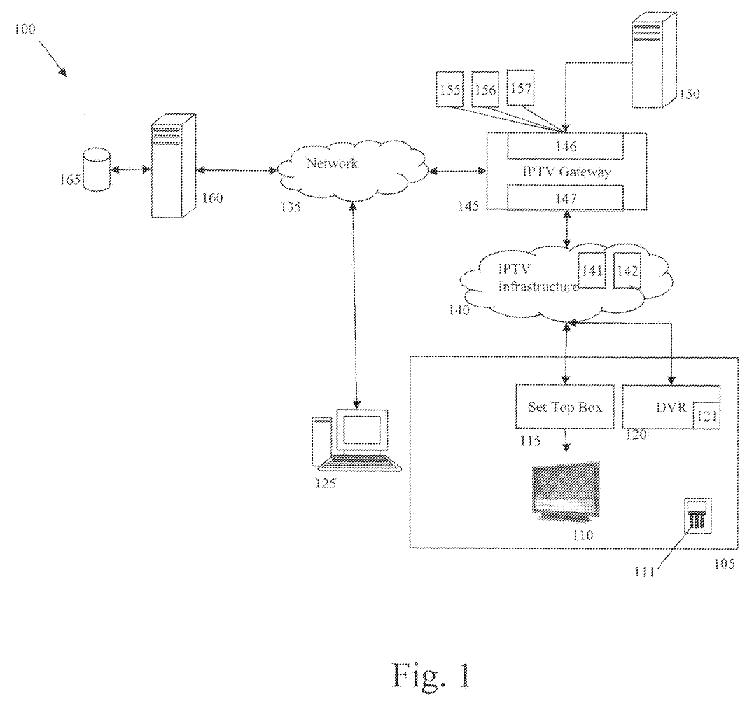

Turning now to FIG. 1, a block diagram of an exemplary unscheduled program searching, scheduling and recording system 100 is now described. For ease of illustration, the system 100 of FIG. 1 depicts a simplified network infrastructure. In addition, for ease of illustration, the system 100 is described as implementing an Internet Protocol Television (IPTV) system for reception of programming and scheduling. It is understood that the systems and methods described herein can implement television and program-viewing systems other than IPTV. For example, the system 100 can implement cable, satellite, antenna, etc.

Furthermore, it is understood that a variety of network components/nodes may be utilized in implementing the embodiment described herein. For example, in exemplary embodiments, the system 100 includes a means for accessing network services for multiple disparate devices using a single sign on procedure. Therefore, the system 100 manages accounts, each of which is established for a community of devices and/or device subscribers, such as those devices and subscribers in a subscriber location 105, which may include a communications device 110 (e.g., an IPTV-enabled television) coupled to a set top box 115. Where the communications device 110 is IPTV-enabled, the set top box 115 includes a processor that provides bi-directional communications between an IPTV infrastructure 140 and the communications device 110 and decodes the video streaming media received as content programming and onscreen programming information, from a content services provider server 160, discussed further below. Other services can be provided to the subscriber location, such as, but not limited to phone services, network services and other exemplary services such as the unscheduled program searching, scheduling and recording services that can be implemented via the communications device 110. The accounts may thus include phone, network access and IPTV services and may be used to provide access to the unscheduled program searching, scheduling, and recording services as described further herein. Furthermore, in exemplary embodiments, one of the devices (e.g., the communications device 110) can be provisioned for the network services described herein by associating a device identifier of the communications device with a respective account. The account, in turn, identifies each of the communications devices belonging to the community and provides other information as described herein. Furthermore, it is appreciated that other devices such as a subscriber computer 125 can be further included in the community of devices established for the subscriber location 105. It is appreciated that the subscriber computer 125 can be local to the subscriber location 105 or can represent any other remote computer that can be used to access the services described herein. It is further appreciated that other remote devices can be implemented to access the services described herein such as but not limited to a cellular telephone (e.g., a 3G cell phone), a personal computer, a laptop computer, a portable computing device (e.g., personal digital assistant), a digital music player (e.g., MP3 player), etc. As discussed further herein, an unscheduled program searching, scheduling, and recording services interface can be rendered on any of the above-referenced devices to implement the unscheduled program searching, scheduling, and recording services in accordance with exemplary embodiments.

In exemplary embodiments, one of the devices, such as the communications device 110 (and the set top box 115 combination) can be used to establish account services, such as the unscheduled program searching, scheduling, and recording services described herein. An account record may be generated for the subscriber at the subscriber location 105, which identifies the subscriber and the account for which the services (e.g., basic account services as described above and the unscheduled program searching, scheduling, and recording services described herein) are provided. Account information and records may be stored in a storage device accessible by an IPTV gateway 145, discussed below. In exemplary embodiments, the IPTV gateway 145 implements one or more applications for establishing and utilizing the unscheduled program searching, scheduling, and recording services account. Access to the unscheduled program searching, scheduling, and recording services account may thus be created for a community of communications devices (e.g., the communications device 110) to enable the communications devices to implement the unscheduled program searching, scheduling, and recording services as described herein. A preferences server 150, which is coupled to the IPTV gateway 145, includes preferences information for the subscriber location 105 as described further herein.

As discussed above, the system 100 of FIG. 1 includes the subscriber location 105, such as the subscriber's household. The subscriber location 105 can include the communications device 110 (e.g., an IPTV-enabled television) in communication with the set top box 115. The subscriber location 105 can further include a personal digital recorder such as a DVR 120, which is in communication with the communication device 110 and the set top box 115. It is understood that the set top box 115 and the DVR 120 may be two separate devices or be a single integrated device. In exemplary embodiments, the DVR 120 is hard-disk based, but may have other suitable storage media such as a cache 121. It is appreciated that the DVR 120 can have other suitable memory devices for receiving and storing programming and scheduling data. Therefore, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

The subscriber location 105 can further include a remote control 111 for control and navigation of the communications device 110. As further described herein the remote control 111 can be implemented to navigate an unscheduled program searching, scheduling, and recording services interface. As discussed above, the subscriber location 105 can further include one or more remote devices in its community of devices. For example, the remote devices can include the remote subscriber computer 125. In exemplary embodiments, the remote subscriber computer 125 can be part of the subscriber location 105 or a computer that is accessed remotely in order to access the unscheduled program searching, scheduling, and recording services for control, management and scheduling of video content (e.g., content for recording on the DVR 120) from the content services provider server 160 to the subscriber location 105 for rendering on the communications device 110. It is therefore appreciated that access to the unscheduled program searching, scheduling, and recording services can be managed from location remote to the subscriber location 105. It is understood by those skilled in the art that the remote subscriber computer 125 can include input and output devices, such as but not limited to a display, mouse, and a keyboard. As discussed further below, the aforementioned devices can all interact with the IPTV infrastructure 140 and the IPTV gateway 145. It is appreciated that any of the aforementioned devices can implement the unscheduled program searching, scheduling, and recording services. In exemplary embodiments, the communications devices herein can have a network address associated with the communications devices such as an addressable uniform resource locator (URL), an Internet address.

The system 100 can implement the unscheduled program searching, scheduling, and recording services such that desired recording control, management and scheduling can be managed and viewed through the subscriber's IPTV-enabled device, such as the communications device 110, via the set top box 115, the remote devices (e.g., the remote subscriber computer 125, etc.) or other suitable device. As such, to coordinate IPTV communication, the system 100 may further include the IPTV gateway 145 that is in communication with the IPTV infrastructure 140. The IPTV infrastructure 140 and the IPTV gateway 145 are used in conjunction to communicate via a network 135. For example, a suitable device (e.g., the communications device 110, the remote subscriber computer 125) at the subscriber location 105 can use the IPTV infrastructure 140 and the IPTV gateway 145 to communicate with the content services provider server 160 to access data from databases such as a database 165.

The network 135 can be an IP-based network for communication between the content services provider server 160 and the subscriber location 105 using communication devices such as but not limited to the communications device 110 (via the set top box 115, for example). The network 135 can be implemented to transmit content from the content services provider server 160 to the subscriber location 105 via a broadband connection, for example. In exemplary embodiments, the network 135 can be a managed IP network administered by a service provider. The network 135 can also be implemented in a wireless fashion, e.g., using wireless protocols and technologies, such as Wi-Fi, Wi-Max, etc. The network 135 can also be a cellular communications network, a fixed wireless network, a wireless local area network (LAN), a wireless wide area network (WAN), a personal area network (PAN), intranet, metropolitan area network, Internet network, or other similar type of network environment or other suitable network system and includes equipment for receiving and transmitting signals. In other exemplary embodiments, the network 135 can be a circuit-switched network such as a standard public switched telephone network (PSTN).

In exemplary embodiments, the IPTV infrastructure 140 can be an IP-based network that receives network data (e.g., programming content for recording on the DVR 120) from the content services provider server 160 and the preferences server 150, and delivers the network data to the set top box 115 for display or other rendering on the communications device 110. Alternatively, the network data can be for display or rendering on the remote subscriber computer 125 or other suitable device.

In exemplary embodiments, as discussed above, the IPTV infrastructure 140 provides an interface between the subscriber location 105 and the IPTV gateway 145. In exemplary implementations, a notification server 141 and a terminal server 142 operate to interface communication between the subscriber location 105 via the set top box 115, and the IPTV gateway 145. For example, in exemplary implementations, the set top box 115 can provide a unique identification number so that the IPTV gateway 145 can route the network data to the set top box 115. As such, a message is passed between the notification server 141 and the set top box 115. The IPTV gateway 145 provides an interface between the content services provider server 160, and the IPTV infrastructure 140 and the subscriber location 105. Furthermore, in exemplary embodiments, the IPTV gateway 145 handles notifications to the IPTV subscriber location 105 and can further provide a history of the notifications. An unscheduled program searching, scheduling, and recording services application 155 can reside partially or wholly on the IPTV gateway 145 to handle the notifications as further described herein. In exemplary embodiments, the unscheduled program searching, scheduling, and recording services application 155 can further reside partially or wholly on the set top box 115. When the subscriber sets up the unscheduled program searching, scheduling, and recording services on the communications device 110 (or other device in the subscriber location 105 and/or the remote device 125), one of the network components of the system 100 (e.g., the set top box 115, the IPTV gateway 145,) can store specific scheduling information that the subscriber has created. For example, as discussed further herein, each subscriber can access and manipulate viewing and recording information for the DVR 120 via an interface. As such, if the interface is stored on the IPTV gateway 145, messages and notifications can be passed between the subscriber location 105 and the IPTV gateway 145 that include present scheduling and historic scheduling that the subscriber has created in the past. Furthermore, if any changes in the subscriber's scheduled recordings have occurred, messages can be passed to the subscriber location 105 (or the remote device 125) to notify the subscriber that a program scheduled to be recorded on the DVR 120 has changed. The subscriber can make changes accordingly.

In exemplary embodiments, the IPTV gateway 145 can further interface with the various system 100 elements as described herein. For example, the IPTV gateway 145 is in communication with the preferences server 150 to pass notifications and messages (e.g., Email messages) regarding permissions to create and edit the unscheduled program searching, scheduling, and recording information. For example, different members of the subscriber location 105 who share account services may have different recording schedules. For example, one member may have a unique recording schedule and another member may have a second unique recording schedule with little to no overlap with the first recording schedule. Furthermore, each of the family members may be interested in the future scheduling of a variety of currently and unrelated unavailable programs. As such, each member can retrieve and edit those different schedules and be properly authenticated to retrieve and edit those schedules.

In exemplary embodiments, the IPTV gateway 145 can include a back end 146 and a front end 147. The front end 147 can be used to implement various provisioning activities such as but not limited to initial provisioning of IPTV addresses for the devices at the subscriber location 105. The back end 146 can be implemented for many of the unscheduled program searching, scheduling, and recording services, such as but not limited to communicating with the content services provider server 160 and retrieving scheduling data from the database 165 and passing messages and notification to the IPTV gateway 145. As such, the back end 146 can include various elements including but not limited to a caller ID handler, an email handler, a message handler and a provisioning handler.

In exemplary embodiments, the IPTV gateway 145 may implement authentication using a high-speed processing device (e.g., a computer system) that is capable of handling high volume activities conducted via communications devices, and other network entities (e.g., parts of the IPTV infrastructure 140, network 135) via one or more networks (e.g., the IPTV infrastructure 140). The IPTV gateway 145 receives requests from one or more devices from the subscriber location 105 to access network services, such as the unscheduled program searching, scheduling, and recording services. The IPTV gateway 145 may implement authentication software for restricting or controlling access to network. The IPTV gateway 145 may be in communication with a customer identity system (CIS) database, which stores subscriber credentials (e.g., subscriber names and passwords) established via the unscheduled program searching, scheduling, and recording services account.

In exemplary embodiments, the system 100 can further include the unscheduled program searching, scheduling, and recording services application 155 that can reside on the IPTV gateway 145, as mentioned above. In exemplary embodiments, the unscheduled program searching, scheduling, and recording services application 155 can be implemented by the subscriber to access and set up an interface 156 to implement the unscheduled program searching, scheduling, and recording services 155. The interface 156 can be implemented to search for and schedule programs on the DVR 120. The interface 156 can further be implemented to access account information from the IPTV gateway 145 and the preferences server 150. In exemplary embodiments, the unscheduled program searching, scheduling, and recording services application 155 can include pointers to the content services provider server 160 for accessing scheduling information and for directing content to be recorded on the DVR 120. The pointers, in turn, provide access to the schedules stored in the database 165 for streaming to the subscriber's set top box 115 for rendering on the interface 156. The system can further include a preferences folder 157 into which meta data is stored from the subscriber. The meta data can include as much detail as possible about a program that has not been identified for any future release such as a movie that is just released in a theatre, but not yet available for home viewing (e.g., DVD, HD-DVD, Blu-Ray, HBO and other premium channels). The preferences folder 157 can therefore be implemented for a specific subscriber. In exemplary embodiments, the preferences folder 157 can also be implemented for multiple subscribers. For example, if X number of subscribers desire movie A and Y number of subscribers desire movie B, two entries A and B can be made into the preferences folder 157 along with pointers to all subscribers X and Y respectively. When the movies become available, notifications can be sent to all of the subscribers regarding the availability of the movies. In exemplary embodiments, the preferences folder 157 is accessible by the content services provider server 160 for updating.

In exemplary embodiments, the interface 156 also provides access to the IPTV gateway 145, such that messages and notifications can be passed between the subscriber location 105 and the IPTV gateway 145 that include present scheduling and historic scheduling that the subscriber has been created in the past. Furthermore, if any changes in the subscriber's scheduled videos have occurred, messages can be passed to the subscriber location 105 (or the remote device 125) to notify the subscriber that a program scheduled to be viewed has changed. The subscriber can make changes accordingly.

In exemplary embodiments, as discussed above, the system 100 further includes the content services provider server 160, which is in communication with the IPTV gateway 145 via the network 135. In exemplary embodiments, the content services provider server 160 is implemented by a host system (e.g., a high-speed processing device) that provides content to its subscribers (e.g., a subscriber of the communications device 110), such as television programs, premium programming services, video on demand content, and Internet/Web content (e.g., podcasts, streaming media, etc.). In exemplary embodiments, the content is transmitted to the subscribers (e.g., at subscriber location 105) via a broadband connection over an Internet Protocol (IP)-based network (e.g., the network 135). The content services provider server 160 can also provide an onscreen electronic programming guide to customers (e.g., user of program receiving device) that provides information about current and future programming available via the content providers' services. Programming information provided by the onscreen electronic programming guide may include current and future program listings including program titles, primary actors/actresses, begin time, duration of program, a year in which the program was produced, and a brief text description of the program. Furthermore, the content services provider server 160 can provide data to subscribers for programs that are to be released in the future, but at present do not have a definitive schedule. In exemplary embodiments, subscribers can mark the program for future release, which can be stored in the preferences folder 157. Therefore, when the program is available for scheduling the subscribers can be notified accordingly.

In exemplary embodiments, the content services provider server 160 is coupled to the database 165. In a one implementation, the database 165 may be representative of a given play list. A play list is associated with a particular program screen. For example, a play list can be generated for a given screen that is displayed for a view on the communications device 110. As a subscriber is browsing through different channels, and therefore different program content, as each new channel and program content are displayed on the communications device 110, a different play list is accessed by the communications device 110 from the content services provider server 160, which can be via the set top box 115. In exemplary embodiments, play lists can include programming content, as well as programming schedules for the content (e.g., onscreen programming guide information). In exemplary embodiments, the database 165 stores records of programming events scheduled for transmission to customers, such as communications device. These records, in turn, can be used in conjunction with the DVR 120 in order to schedule recordings.

In exemplary embodiments, upon a request from the subscriber location 105, the IPTV gateway 145 can coordinate obtaining the video from the database 165 and provide the acquired data (e.g., playlists and selected programs) for display and rendering at the subscriber location 105. As described, the coordination of acquiring the data and ultimately displaying the data on the communications device 110 (or other device) is implemented via the unscheduled program searching, scheduling, and recording services application 155. Furthermore, the unscheduled program searching, scheduling, and recording services application 155 coordinates the transfer of the program data from the database 165 for rendering on the communications device and for recording on the DVR 120.

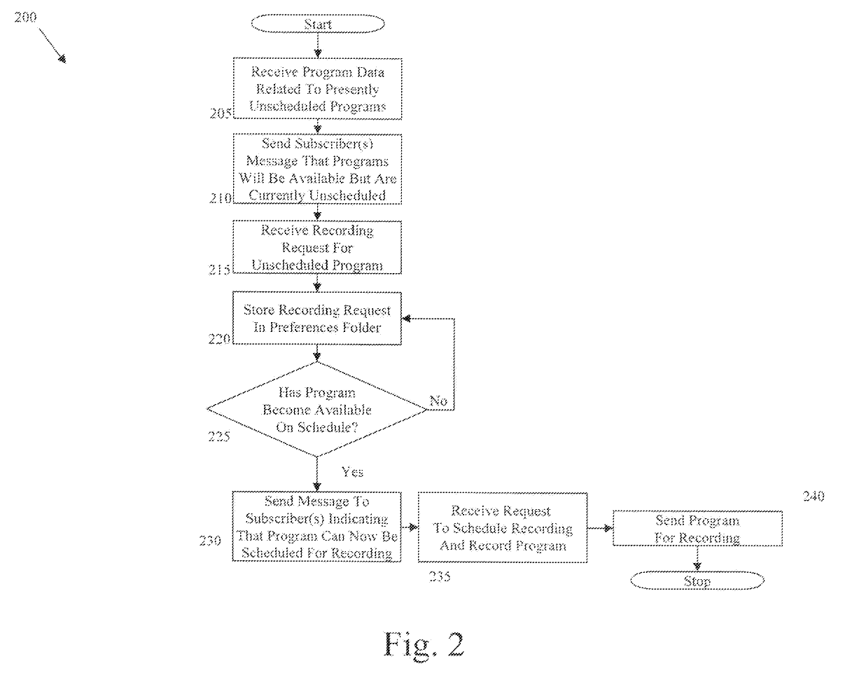

FIG. 2 illustrates a flow chart of an unscheduled program searching, scheduling, and recording method 200 in accordance with exemplary embodiments. As discussed above, in exemplary embodiments, if a subscriber wants to search for and possibly record a program on the DVR 120 but the program has not yet been scheduled or released, the systems and methods described herein can search for programs that have been identified for release at some future date. As such, the subscriber can alert the content provider that the subscriber would like to schedule and record the program when it is released.

At step 205, the unscheduled program searching, scheduling, and recording services application 155 can receive program data related to presently unscheduled programs. In exemplary embodiments, the program data is received in the IPTV gateway 145 (e.g., via the unscheduled program searching, scheduling, and recording services application 155) from the content services provider server 160. At step 210, the unscheduled program searching, scheduling, and recording services application 155 sends the subscriber (or multiple subscribers) a message that programs are to be available but are currently unscheduled. At step 215, the unscheduled program searching, scheduling, and recording services application 155 receives a recording request for an unscheduled program. At step 220, the recording request is stored in the preferences folder 157. At step 225, the unscheduled program searching, scheduling, and recording services application 155 determines whether or not the program has become available. It is appreciated that step 225 can occur periodically over an extended time period depending on the availability of the program. In exemplary embodiments, the subscriber can also manually request that the application 155 determine whether or not the program has become available. As such, if the program is not available at step 225, the recording request remains stored in the preferences folder 157 at step 220. If the program has become available at step 225, then at step 230 a message is sent to the subscriber indicating that the program can now be scheduled for recording. If the subscriber does want to schedule a program for recording, the subscriber can then send a schedule request that is received by the unscheduled program searching, scheduling, and recording services application 155 at step 235. In exemplary embodiments, the application 155 can also automatically schedule the program for recording one a determination is made that the program is available. When the scheduling time occurs, then the program is sent for recording at step 240. It is appreciated that further reminder messages can be sent to the subscriber location 105 if the subscriber has not indicated a recording time. In addition, the subscriber can send a message back to the unscheduled program searching, scheduling, and recording services application 155 indicating that the subscriber no longer desires to receive notifications for the particular program.

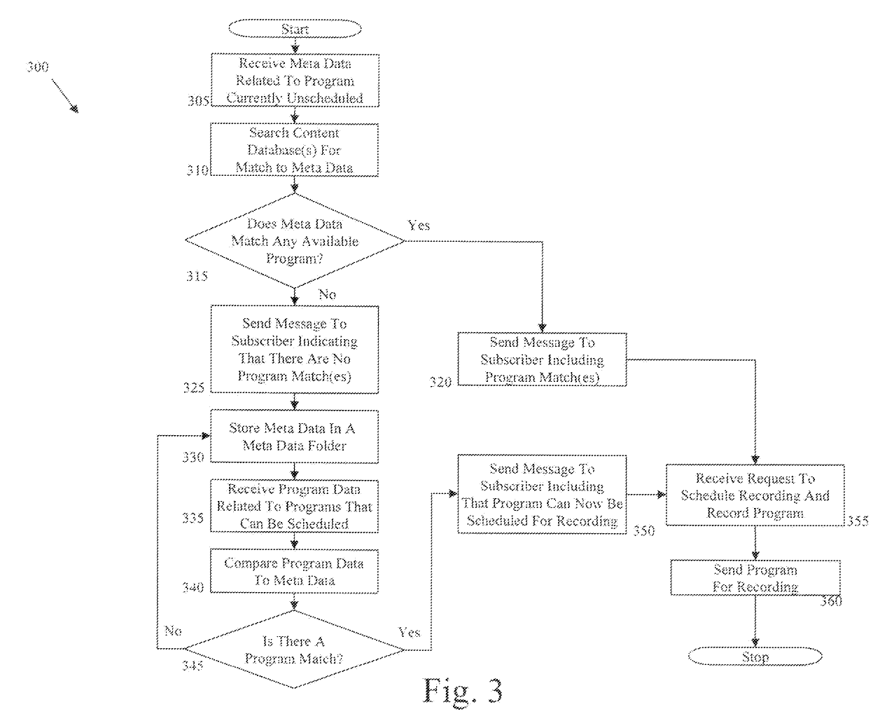

FIG. 3 illustrates a flow chart of an unscheduled program searching, scheduling, and recording method 300 in accordance with exemplary embodiments. As discussed above, in other exemplary embodiments, the preferences folder 157 can as much meta-data as possible such that a content provider can periodically access the folder to ascertain whether a newly released or soon to be released program matches the preference data. As such, a subscriber can provide meta-data to the folder 157, and the content provider can send a message to the subscriber if there is a future match.

At step 305, the unscheduled program searching, scheduling, and recording services application 155 receives meta-data from the subscriber related to an unscheduled program. At step 310, the unscheduled program searching, scheduling, and recording services application 155 searches (or sends a request for a search to the content services provider server 160) for a program match to the meta-data. It is appreciated that the subscriber may be unaware that the program is available. Therefore, if there is a match at step 315, the subscriber is sent a message that there is a program match at step 320. At step 355, if the subscriber sends a recording request, the unscheduled program searching, scheduling, and recording services application 155 receives the recording request. Then at step 360, when the recording time occurs, the program is sent to the subscriber.

Returning to step 315, if there is no program match, indicating that the program is presently not available for scheduling, then at step 325, the subscriber is sent a message that there are presently no program matches, but that the meta-data has been recorded in the preferences folder 157, at step 330. At step 335, the unscheduled program searching, scheduling, and recording services application 155 receives program data related to programs that can currently be scheduled (e.g. from the content services provider server 160). At step 340, the unscheduled program searching, scheduling, and recording services application 155 compares the program data to the meta-data in the preferences folder 157. At step 345, the unscheduled program searching, scheduling, and recording services application 155 determines whether or not there is a program match. If there is no program match then the meta-data is held in the preferences folder 157 at step 330 and the comparison repeats if new program data is received at step 335. If at step 345, there is a program match, then at step 350, a message is sent to the subscriber that the program can now be scheduled for recording. If the subscriber does want to schedule a program for recording, the subscriber can then send a schedule request that is received by the unscheduled program searching, scheduling, and recording services application 155 at step 355. In exemplary embodiments, the application 155 can also automatically schedule the program for recording once a determination is made that the program is available. When the scheduling time occurs, then the program is sent for recording at step 360. It is appreciated that further reminder messages can be sent to the subscriber location 105 if the subscriber has not indicated a recording time. In addition, the subscriber can send a message back to the unscheduled program searching, scheduling, and recording services application 155 indicating that the subscriber no longer desires to receive notifications for the particular program.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An unscheduled program searching, scheduling, and recording method, comprising:
receiving program data related to a currently unscheduled program;
receiving a recording request for scheduling recording of the currently unscheduled program at a date when the currently unscheduled program becomes available as a scheduled program;
storing the recording request for the currently unscheduled program; and
in response to the currently unscheduled program becoming available as the scheduled program, scheduling the scheduled program for recording.

2. The method as claimed in claim 1, further comprising sending a message that program data for the currently unscheduled program is available.

3. The method as claimed in claim 1 wherein scheduling the scheduled program for recording comprises receiving a scheduling request in response to the currently unscheduled program becoming available as the scheduled program.

4. The method as claimed in claim 1, further comprising sending the program for recording on a digital video recorder.

5. The method as claimed in claim 1, further comprising sending a message that the program can be scheduled for recording.

6. The method as claimed in claim 1, further comprising retaining the recording request in a preferences folder in response to the currently unscheduled program being unavailable for scheduling.

7. The method as claimed in claim 1, wherein the recording request is stored in a preferences folder.

8. An unscheduled program searching, scheduling, and recording system, comprising:
a processor communicating with memory, the memory storing processor-executable instructions for:
receiving program data related to a currently unscheduled program;
receiving a recording request for scheduling recording of the currently unscheduled program at a date when the currently unscheduled program becomes available as a scheduled program;
storing the recording request for the currently unscheduled program; and
in response to the currently unscheduled program becoming available as the scheduled program, scheduling the scheduled program for recording.

9. The system as claimed in claim 8, the memory further storing instructions for sending a message that program data for the currently unscheduled program is available.

10. The system as claimed in claim 9, wherein scheduling the scheduled program for recording comprises receiving a scheduling request in response to the currently unscheduled program becoming available as the scheduled program.

11. The system as claimed in claim 8, the memory further storing instructions for sending the program for recording on a digital video recorder.

12. The system as claimed in claim 8, the memory further storing instructions for sending a message that the program can be scheduled for recording.

13. The system as claimed in claim 8, the memory further storing instructions for retaining the recording request in a preferences folder in response to the currently unscheduled program being unavailable for scheduling.

14. The system as claimed in claim 8, wherein the recording request is stored in a preferences folder.

15. A computer program product for providing unscheduled program searching, scheduling, and recording services, the computer program product including instructions for causing a computer to implement a method, comprising:
receiving program data related to a currently unscheduled program;
receiving a recording request for scheduling recording of the currently unscheduled program at a date when the currently unscheduled program becomes available as a scheduled program;
storing the recording request for the currently unscheduled program; and
in response to the currently unscheduled program becoming available as the scheduled program, scheduling the scheduled program for recording.

16. The computer program product as claimed in claim 15, further comprising instructions for sending a message that program data for the currently unscheduled program is available.

17. The computer program product as claimed in claim 16, wherein scheduling the scheduled program for recording comprises receiving a scheduling request in response to the currently unscheduled program becoming available as the scheduled program.

18. The computer program product as claimed in claim 15, further comprising instructions for sending the program for recording on a digital video recorder.

19. The computer program product as claimed in claim 15, further comprising instructions for sending a message that the program can be scheduled for recording.

20. The computer program product as claimed in claim 15, further comprising instructions for retaining the recording request in a preferences folder in response to the currently unscheduled program being unavailable for scheduling.

21. An unscheduled program searching, scheduling, and recording method, comprising:
receiving meta-data, the meta-data being related to a currently unscheduled program; and
storing the meta-data for the currently unscheduled program in a preferences folder.

22. An unscheduled program searching, scheduling, and recording method, comprising:
receiving and storing meta-data related to a currently unscheduled program;
receiving program data related to the currently unscheduled program indicating that the currently unscheduled program is available for scheduling;
comparing the meta-data to the program data; and
if the meta-data matches the program data, then scheduling the program for recording.
